(19) United States
(12) Patent Application Publication
(10) Pub. No.: US 2021/0245734 A1
(43) Pub. Date: Aug. 12, 2021

(54) VEHICLE CONTROL DEVICE AND AUTOMATIC DRIVING SYSTEM USING SAME

(71) Applicant: Hitachi Automotive Systems, Ltd., Hitachinaka-shi, Ibaraki (JP)

(72) Inventors: Tatsunori HARAI, Hitachinaka-shi (JP); Reona MOCHIZUKI, Hitachinaka-shi (JP)

(73) Assignee: Hitachi Automotive Systems, Ltd., Hitachinaka-shi, Ibaraki (JP)

(21) Appl. No.: 16/973,257

(22) PCT Filed: Jul. 11, 2019
(86) PCT No.: PCT/JP2019/027449

§ 371 Date: Dec. 8, 2020

(30) Foreign Application Priority Data
Jul. 26, 2018 (JP) 2018-140764

(51) Int. Cl. B60W 30/06; G05D 1/00; B60W 50/14

(52) U.S. Cl. CPC B60W 30/06; B60W 50/14; G05D 1/0016

(57) ABSTRACT

Provided is an activation method for a control application, which is more safe, reliable, and comfortable. By collating recorded peripheral information with a currently acquired peripheral environment, it is determined whether remote automatic parking is possible, and a remote control application executed by a mobile communication device is activated.

### TECHNICAL FIELD

The present invention relates to a vehicle control device that performs vehicle control for parking an own vehicle at a final parking position by automatic driving, and an automatic driving system using the same.

### BACKGROUND ART

Vehicles that control automatic driving with smartphone applications have appeared. By connecting the vehicle and the smartphone via wireless communication and using a dedicated smartphone application, the user can move the vehicle from outside the vehicle. On the other hand, the procedure for activating the application for controlling the vehicle becomes complicated for a user.

PTL 1 discloses a technique for automatically activating a control application when a smartphone approaches a vehicle.

### CITATION LIST

### Patent Literature

PTL 1: JP 2015-21247 A

### SUMMARY OF INVENTION

### Technical Problem

In PTL 1, the control application of the smartphone is activated by a trigger according to position information based on GPS. However, for example, when the control application is activated in association with the automobile while the vehicle is running, the behavior of activating and ending the control application must not be unstable, and when position information such as GPS where there is a concern about an error is used, there are concerns about uncertain activation and unintended activation.

The present invention has been made in view of the above matters, and an object of the present invention is to provide a vehicle control device capable of activating a control application more safely, reliably, and comfortably, and an automatic driving system using the same.

### Solution to Problem

In order to solves the above-mentioned problem, according to the present invention, there is provided a vehicle control device, including: a storage unit that stores a running route to a final parking position and peripheral obstacles; a self-position estimation unit that estimates an own vehicle position based on information from an outside world recognition unit; and a remote control determination unit that determines that remote automatic parking of the own vehicle is possible based on information stored in the self-position estimation unit and information stored in the storage unit, in which the remote control determination unit compares the information from the self-position estimation unit and the information from the storage unit, and determines that the remote automatic parking is possible on a condition that it is determined that the own vehicle is on the running route stored in advance.

### Advantageous Effects of Invention

According to the present invention, by collating the peripheral information recorded in the storage unit with a currently acquired peripheral environment, it is determined whether automatic driving of moving the own vehicle to the final parking position is possible, and an automatic driving control application executed by the mobile communication device is automatically activated. Thus, it is possible to reduce the number of user operation procedures required to execute automatic driving, and it is possible to provide an automatic driving system that is easier to handle.

Further features related to the present invention will be apparent from the description of the present specification and the accompanying drawings. Moreover, problems, configurations, and effects other than those described above will be clarified by the following description of embodiments.

### BRIEF DESCRIPTION OF DRAWINGS

FIG. 1 is a configuration diagram of a vehicle to which a vehicle control device according to an embodiment of the present invention is applied.

FIG. 2 is a configuration diagram of the vehicle control device according to the embodiment of the present invention.

FIG. 3 is a functional block diagram of the vehicle control device according to the embodiment of the present invention.

FIG. 4 is a diagram illustrating an internal function of the vehicle control device according to the embodiment of the present invention.

FIG. 5 is a diagram showing an example of a route of automatic parking.

FIG. 6 is a diagram illustrating a configuration of a mobile terminal.

FIG. 7 is a diagram showing an example of an operation button displayed on a display unit of a mobile terminal.

FIG. 8 is a flowchart illustrating a process of transmitting an activation trigger.

### DESCRIPTION OF EMBODIMENTS

As an example, a vehicle equipped with a control device that automates a parking operation will be described.

[Vehicle Configuration]

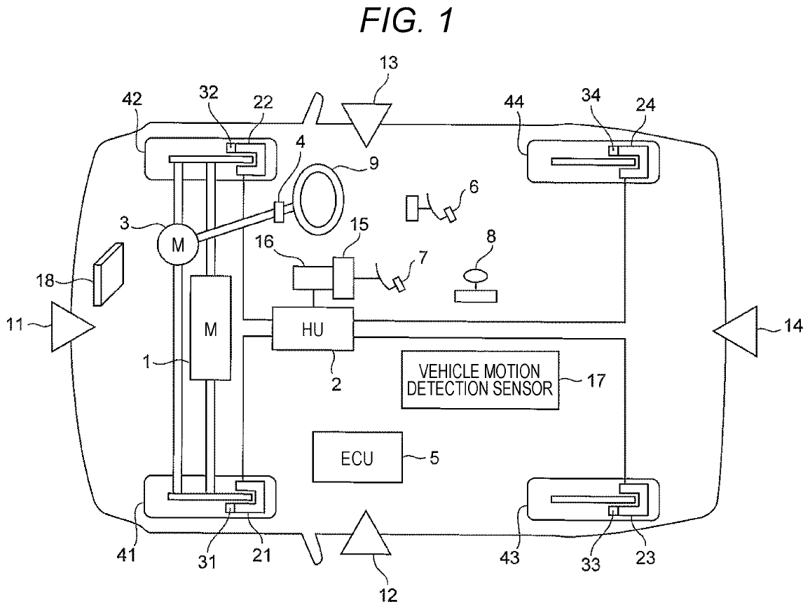

FIG. 1 is a configuration diagram of a vehicle to which a vehicle control device according to an embodiment of the present invention is applied.

A driver designates forward movement, backward movement, and stop of own vehicle by a shift lever 8, and determines a driving force of a drive motor 1 by an accelerator pedal 6. The drive motor 1 may be an engine. The drive motor 1 can generate a driving force and a braking force regardless of an accelerator pedal operation and a shift operation of the driver.

A pedaling force of a brake pedal 7 is boosted by a brake booster 15, and a hydraulic pressure corresponding to the force is generated in a master cylinder 16. The generated hydraulic pressure is supplied to wheel cylinders 21 to 24 via an electro-hydraulic brake 2. In this way, the driver controls the braking force by the brake pedal 7. The electro-hydraulic brake 2 has built therein a pump driven by a motor, a solenoid valve, etc., and can independently control braking forces of the four wheels (hydraulic pressures of the wheel cylinders 21 to 24) regardless of a brake pedal operation of the driver.

An electric power steering 3 generates an assist torque according to a steering torque input by the driver via a steering wheel 9. Left and right front wheels (steered wheels) 41 and 42 are steered by the steering torque of the driver and the assist torque of the electric power steering 3, and the own vehicle turns while the vehicle is running. In addition, the electric power steering 3 generates a steering torque regardless of a steering operation of the driver, and can steer the left and right front wheels 41 and 42.

In addition, four cameras 11 to 14 that monitor the area in the periphery of the vehicle and recognize objects in the periphery of the vehicle are attached to the front, rear, left, and right of the vehicle. The images of the four cameras 11 to 14 are combined and displayed on a touch panel 18 as a bird's-eye view of the own vehicle and its periphery from above. The driver can park while looking at this bird's-eye view without control of parking assistance.

The vehicle control device recognizes the parking position based on the parking frame on the images of the cameras 11 to 14 and positions of other parked vehicles, and controls the drive motor 1, the electro-hydraulic brake 2, and the electric power steering 3 so that the own vehicle reaches the recognized parking position. It is also possible for the driver to designates the parking position using the touch panel 18 on which the bird's-eye view is displayed.

Further, in order to control the parking route, a steering angle sensor 4 and wheel speed sensors 31 to 34 are attached. The electro-hydraulic brake 2 prevents skidding of the own vehicle and performs anti-lock braking control based on sensor signals from a vehicle motion detection sensor 17, the steering angle sensor 4, and the wheel speed sensors 31 to 34 that detect front-rear acceleration, lateral acceleration, and a yaw rate, and the signals of the steering angle sensor 4 and the wheel speed sensors 31 to 34 are shared with the control of parking assistance.

All of the electric devices mentioned above are controlled by an electronic control unit (ECU) 5, and all the sensor signals are also input to the electronic control unit 5. The sensor signals also include an accelerator pedal operation amount, a brake pedal operation amount, a shift position, and a steering torque, which are operation amounts of the driver. Further, the configuration may be such that the function of the electronic control unit 5 is divided, the electronic control unit is attached to each electric device, and necessary information can be communicated between the electronic control units.

The drive motor 1, the electro-hydraulic brake 2, the wheel cylinders 21 to 24, the wheels 41 to 44, and the electronic control unit 5 constitute an automobile speed control device that automatically controls the vehicle speed. In addition, the electric power steering 3 and the electronic control unit 5 constitute an automatic steering control device that automatically steers the left and right front wheels 41 and 42.

[Configuration of Vehicle Control Device]

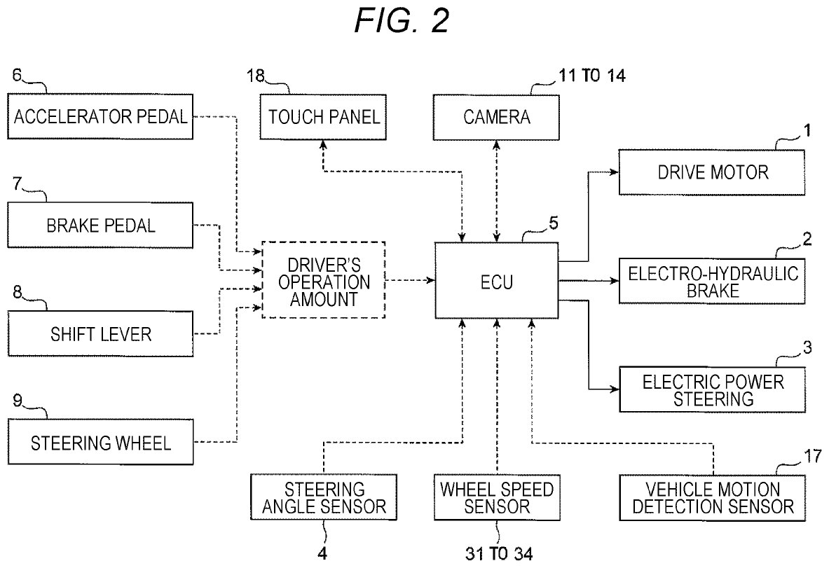

FIG. 2 is a configuration diagram of the vehicle control device of the present embodiment.

During automatic driving, the vehicle operation is automatically controlled by the drive motor 1, the electro-hydraulic brake 2, and the electric power steering 3, but the operation amount of the driver is monitored and override by the driver is possible. For example, when the driver operates the brake pedal 7 during automatic driving, the operation of the own vehicle is temporarily stopped. As a result, when an obstacle enters the running route, the braking operation of the driver is prioritized and contact with the obstacle can be avoided.

After that, when the driver releases the brake, the parking operation by automatic driving is restarted. As a result, parking assistance can be automatically restarted when the obstacle leaves the parking route. In addition, when the driver changes the shift position or the steering torque of the driver becomes equal to or greater than a predetermined value, the parking operation by automatic driving is stopped. As a result, the shift operation or steering operation of the driver can be prioritized to drive the own vehicle. It is also possible to display an automatic control stop button on the touch panel 18 and stop the automatic control by pressing the automatic control stop button.

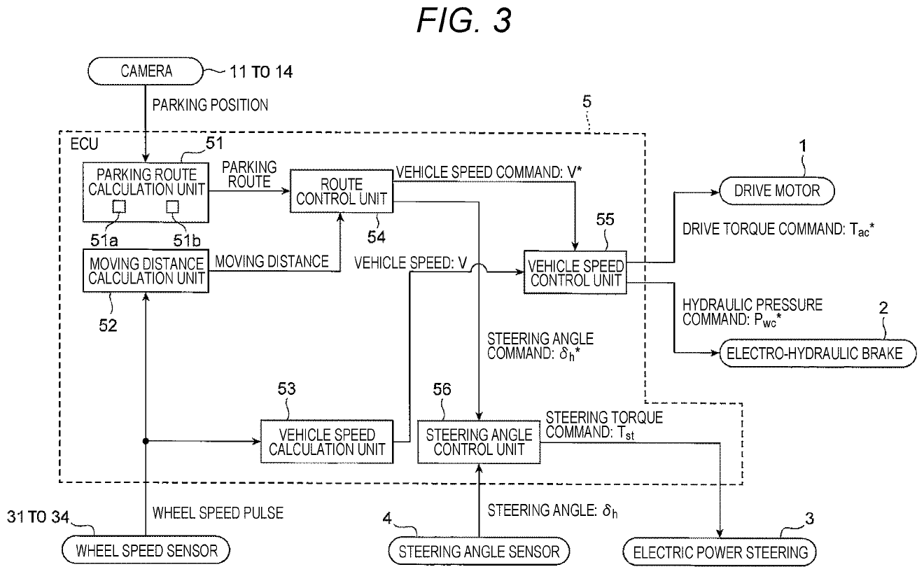

FIG. 3 is a functional block diagram of the vehicle control device according to the present embodiment.

The electronic control unit 5 includes a parking route calculation unit 51, a moving distance calculation unit 52, a vehicle speed calculation unit 53, a route control unit 54, a vehicle speed control unit 55, and a steering angle control unit 56. The parking route calculation unit 51 recognizes the parking position using the images captured by the cameras 11 to 14, calculates the parking route to the parking position, and outputs the parking route to the route control unit 54. The moving distance calculation unit 52 calculates the moving distance of the own vehicle from the wheel speed pulses detected by the wheel speed sensors 31 to 34, and outputs the moving distance to the route control unit 54. The route control unit 54 calculates the vehicle speed and the steering angle based on the parking route and the moving distance, and outputs the vehicle speed and the steering angle to the vehicle speed control unit 55 and the steering angle control unit 56. The vehicle speed control unit 55 outputs a drive torque command and a hydraulic pressure command to the drive motor 1 and the electro-hydraulic brake 2 to control them, and the steering angle control unit 56 acquires information on the steering angle from the steering angle sensor 4, calculates a steering torque command value, and outputs the steering torque command value to the electric power steering 3.

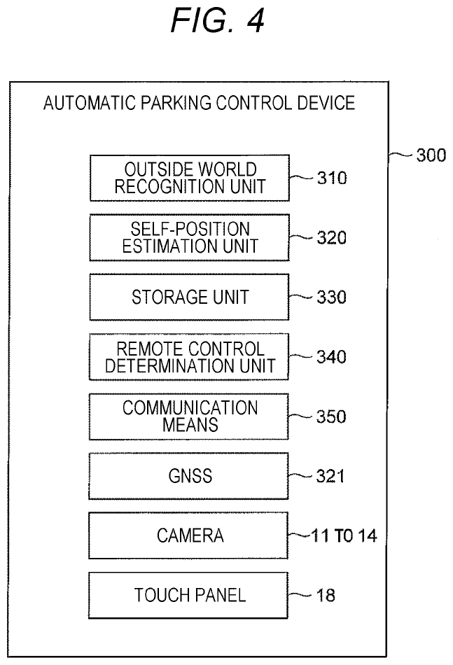

FIG. 4 is a diagram illustrating the internal function of the vehicle control device.

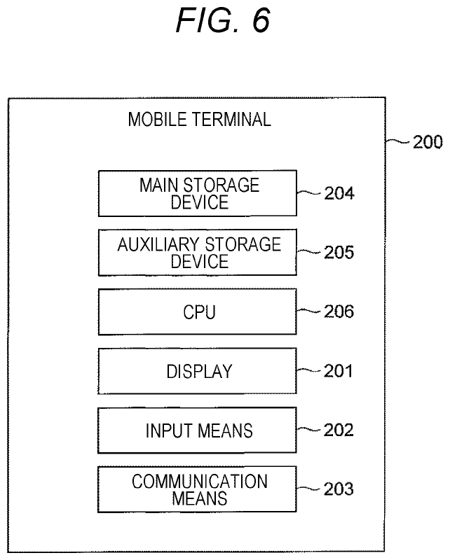

An automatic parking control device 300 is one of the internal functions of the vehicle control device, and is configured inside the electronic control unit 5. The automatic parking control device 300 includes an outside world recognition unit 310, a self-position estimation unit 320, a storage unit 330, and a remote control determination unit 340. Further, a communication means 350 is provided as a transmission unit that transmits the result of the remote control determination unit 340 to the outside such as a mobile terminal 200 (see FIG. 6).

The outside world recognition unit 310 is connected to cameras 11 to 14 of the own vehicle, and can acquire peripheral information including objects (peripheral obstacles) existing in the periphery of the own vehicle and patterns on the road surface. The outside world recognition unit 310 can also acquire peripheral information using a radar or sonar besides the cameras.

The self-position estimation unit 320 estimates the own vehicle position based on the information from the outside world recognition unit 310. The storage unit 330 stores the running route to the final parking position and the peripheral obstacles. The remote control determination unit 340 performs a process of determining that remote automatic parking of the own vehicle is possible based on the information stored in the self-position estimation unit 320 and the storage unit 330. Here, the remote automatic parking means that the user operates the mobile terminal 200, which is a mobile communication device, outside the vehicle to move the own vehicle to the final parking position. The remote control determination unit 340 compares the information from the self-position estimation unit 320 and the information from the storage unit 330, determines that the own vehicle is on a route stored in advance, and then determines that the remote automatic parking is possible.

The self-position estimation unit 320 estimates the own vehicle position by collating the information recorded in the storage unit 330 with the peripheral information acquired from the outside world recognition unit 310. The self-position estimation unit 320 includes a GNSS (Global Navigation Satellite System) 321 and can also detect the position information acquired by the GNSS 321 as the current location of the own vehicle. Further, the self-position of the own vehicle may be calculated by combining the GNSS 321 and the comparison result. The touch panel 18 is provided in the vehicle interior, displays the route to the user, and also displays an operation button of an automatic driving start device.

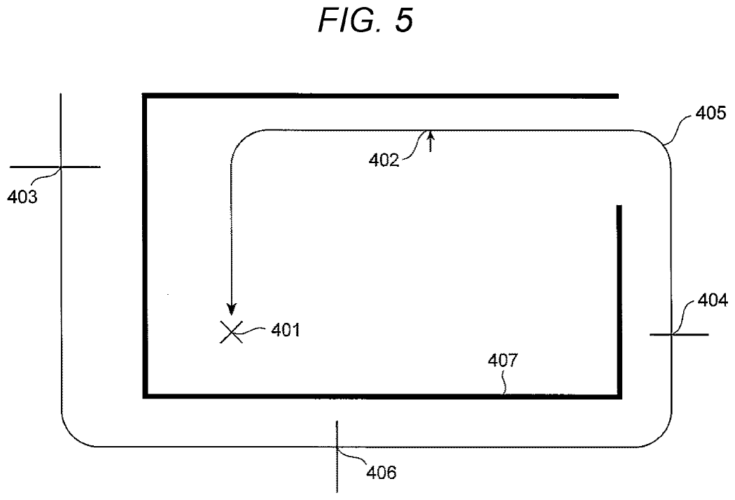

FIG. 5 is a diagram showing an example of a route of the automatic parking. The storage unit 330 records in advance at least one of the self-position in a running route 405 from a recording start point 403 to a final parking position 401 and the peripheral information including the objects (peripheral obstacles) existing in the periphery of the running route 405 and the patterns of the road surface. The recording start point 403 is the position where the recording of the peripheral information is started. This record shall be recorded in advance by the driving operation of the user or the like.

An automatic driving startable start point 406 is set between the recording start point 403 and the final parking position 401. The recording start point 403 may be set as the automatic driving startable start point 406.

The automatic parking control device 300 performs control of automatically driving the own vehicle along the running route 405 by automatic driving at least from the automatic driving startable start point 406 to the final parking position 401. The automatic driving is performed based on the information obtained by various external world recognition means and the like. In the present application, the configuration and method are not limited. The automatic driving may be started by a user operation or may be started automatically. For example, the automatic driving may be started when the remaining running route length (remaining distance) up to the final parking position 401 is equal to or less than a predetermined value.

The communication means 350 transmits the determination result to the mobile terminal 200 when it is determined by the remote control determination unit 340 that remote automatic parking is possible or not possible.

FIG. 6 is a diagram illustrating the configuration of the mobile terminal 200.

The mobile terminal 200 includes a notification unit that gives a notification by at least one of sound vibration or display. As the mobile terminal 200, a general computer equipped with a communication means such as a smartphone or a mobile phone can be used. The mobile terminal 200 includes a display 201, an input means 202, a communication means 203, a main storage device 204, an auxiliary storage device 205, and a CPU 206.

The mobile terminal 200 has a function of being able to communicate with the own vehicle by using the communication means 203. An application executed by the mobile terminal 200 can send and receive signals to and from the own vehicle by using the communication means 203. The mobile terminal 200 and the own vehicle may communicate directly with each other, or a relay device may be provided in the communication path between the mobile terminal 200 and the own vehicle. In addition, communication may be performed via a communication network such as the Internet.

The application for the user to control the automatic parking of the own vehicle is installed in the mobile terminal 200. The automatic parking control application can drive the own vehicle to the final parking position 401 by operating the mobile terminal 200. For example, the user can remotely control the start and stop of the running of the own vehicle by operating the automatic parking control application on the mobile terminal 200, and automatic driving can be performed from outside the own vehicle.

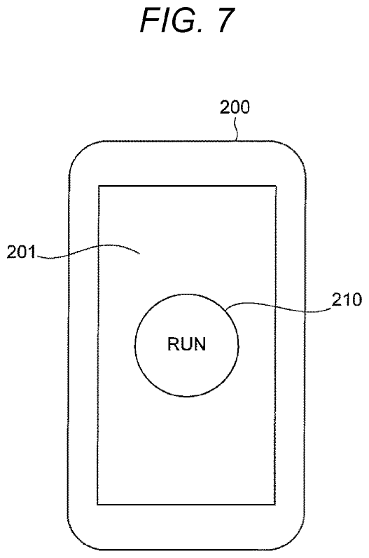

FIG. 7 is a diagram showing an example of the operation button displayed on the display of the mobile terminal.

As shown in FIG. 7, the mobile terminal 200 is, for example, a smartphone and has the display 201 capable of touch input. In the mobile terminal 200, the button 210 is drawn on the touch display 201, and when the user touches the button 210, the own vehicle automatically runs. Further, when the touch to the button 210 is released, the running of the own vehicle may be interrupted.

The automatic parking control application is installed in the mobile terminal 200, and is automatically activated when the mobile terminal 200 receives an activation trigger from the automatic parking control device 300.

Further, when the determination result of the remote control determination unit 340 is that remote automatic parking is possible, the automatic parking control application may be automatically activated. Then, it is possible to notify the user that the automatic parking control application has been activated by any combination of speaker output, vibration output, and screen output (notification unit).

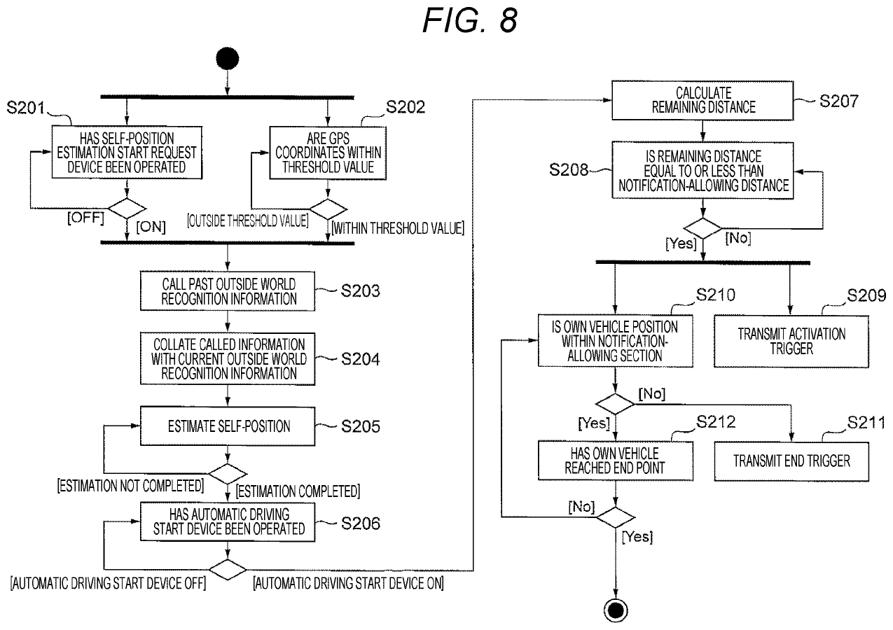

The flow of processing for the activation trigger transmission of the automatic parking control device 300 will be described with reference to FIG. 8. The self-propelled parking control device 300 calls the peripheral information (past outside world recognition information), which is stored in the storage unit 330 and corresponds to the position of the own vehicle (S203), when a predetermined user input has been performed (S201) or the position of the own vehicle acquired by the GNSS (321) is within the predetermined area (S202). Here, the predetermined area is a position where the vehicle is finally parked by automatic parking, or an area corresponding to the recording start point 403. For example, the predetermined area is an area having a predetermined radius from the final parking position 401. As a matter of course, the predetermined area is not limited to this, and may be any other area according to the recorded peripheral information.

In S204, the collation process (matching process) of the peripheral information called in S203 and the peripheral information acquired from the outside world recognition unit 310 is started. Here, the collation is a process of determining whether or not the peripheral information called in S203 and the peripheral information acquired from the outside world recognition unit 310 match. For example, when the peripheral information obtained from the cameras is used, it is determined whether or not the image currently acquired from the cameras matches the image stored in the storage unit 330 as the peripheral information. Information such as peripheral obstacles (for example, 407 in FIG. 5) acquired from the outside world recognition unit 310 is converted into point group data and recorded in the storage unit 330 as peripheral information, and in the collation process, the determination may be made by determining whether or not the result of converting the peripheral information acquired from the outside world recognition unit 310 into the point group data matches the point group data recorded in the storage unit 330. Here, the matching condition does not have to be the case of perfect matching. The degree of matching may be calculated, and it may be determined that they match when the degree of matching is equal to or higher than a set threshold value.

If it is determined in S204 that they match, the self-position of the own vehicle is estimated in S205. At this time, based on the peripheral information recorded in the storage unit 330 and the peripheral information acquired from the outside world recognition unit 310, the calculation of the positional relationship between the obstacles recorded as the peripheral information and the final parking position is started.

When the estimation of the self-position has been completed in S205, it is determined in S206 whether the automatic driving start device has been operated. The automatic driving start device is, for example, a physical operation button provided in the vehicle interior or an operation button displayed on the touch panel 18, and is operated by the user. When the automatic driving start device is operated by the user, the automatic driving of the own vehicle is started, and the own vehicle is moved along the running route.

When the automatic driving of the own vehicle is started by the operation of S206, the remaining distance to the final parking position 401 is calculated in S207. Here, the remaining distance is considered as the running distance in the running route from the self-position to the final parking position 401.

Then, in S208, is determined whether or not the remaining distance between the self-position and the final parking position is equal to or less than a notification-allowing distance. When the remaining distance is equal to or less than the notification-allowing distance, the activation trigger is transmitted in S209. The activation trigger is a trigger for automatically activating the automatic parking control application of the mobile terminal 202. The activation trigger is transmitted when it is determined that remote automatic parking is possible on the condition that the remote control determination unit 340 determines that the own vehicle is on the stored route. That is, when the own vehicle moves toward the final parking position 401 by automatic driving to approach the final parking position 401 at a distance closer than the distance set in advance, the activation trigger is transmitted. Then, in the mobile terminal 200, the automatic parking control application is started by receiving the activation trigger, and the automatic parking is possible by remote control by the mobile terminal 200.

Conditions for transmitting the activation trigger may be further added. For example, in S201 and S202, if the subsequent processing has been performed regardless of the user input, the user input may be accepted and the activation trigger may be transmitted when the predetermined user input is performed.

In S210, it may be determined whether or not the own vehicle is located within a notification-allowing section. When the own vehicle position of the own vehicle is outside the notification-allowing section, an end trigger is transmitted (S211). The end trigger is a trigger for automatically ending the automatic parking control application of the mobile terminal 200. As an example of the notification-allowing section, an area based on the running route 405 is set, and when the own vehicle leaves the area, the end trigger is transmitted. An example of the method of setting the area, there is given an area having a certain width centered on a line when the running route 405 is the line.

In S212, it is determined whether the own vehicle has moved to the final parking position 401 (has reached the end point), that is, whether parking has been completed. When the parking has been completed, the end trigger may be transmitted.

It is possible to prevent activation at an unintended timing by transmitting an activation trigger to automatically activate the control application of the mobile terminal 200 when the recorded peripheral information and the current peripheral information match. For example, if only the position information of the GNSS such as GPS is used as the condition for transmitting the activation trigger, the control application may be activated in an unintended place due to the error of the GNSS. Also, in places where the GNSS cannot be used, such as underground parking lots, the control application cannot be activated automatically. These problems can be solved by performing the collation process of S204.

By starting the collation process of S204 on the condition of the self-position by GPS in S202, the calculation load required for the collation process can be suppressed in the normal time when automatic parking is not performed.

By starting the collation process when a user input is made in S201, it is possible to prevent the control application from being automatically activated unintentionally by the user.

In S210, when the vehicle position goes out of the notification-allowing section, by automatically terminating the control application, it is possible to automatically terminate the control application that is automatically started when, for example, the own vehicle enters the area where it can be automatically parked by the driving of the user, but the user has no intention of parking or no longer has an intention of parking and leaves the parking position.

The control application described above may be activated immediately after the activation trigger is received. Alternatively, a getting-out position 402 may be set so that the control application is activated when the own vehicle stops at the getting-out position. Here, when the own vehicle travels to the getting-out position 402 in the automatic parking on the running route 405, the vehicle is to temporarily stop in order for an occupants to get out. Subsequent control such as restart of automatic parking is controlled by the user using the control application that is automatically activated.

The getting-out position 402 may be set at the time of recording the driving operation in the storage unit 330 by the user. For example, at the time of recording, when the user stops the own vehicle at the position desired to be set to the getting-out position 402 and user input such as operation of the touch panel 18 is made or the user opens and closes the door of the own vehicle, the position is recorded in the storage unit 330 as the getting-out position 402.

The activation timing of the control application may be set based on the arrival timing to the getting-out position 402. The activation timing is set, for example, to be t seconds before the arrival timing. This makes it possible to activate the control application before the arrival timing, so that the user does not have to wait for the activation of the control application after getting out.

The automatic parking control device 300 calculates the arrival timing based on the speed of the own vehicle and the distance to the getting-out position 402, and transmits a control application activation trigger when the current time is t seconds before the arrival timing. Alternatively, the activation timing is transmitted to the mobile terminal 200, and the mobile terminal 200 activates the control application at a timing corresponding to the received activation timing. Instead of making determination at the above timing, the activation trigger transmission position 404 may be set, and the control application may be activated when the own vehicle reaches the activation trigger transmission position 404. The automatic driving startable start point 406, the getting-out position 402, and the activation trigger transmission position 404 are set as the remaining distances to the final parking position 401. Alternatively, these may be set as coordinates or areas.

After the control application is activated, the end trigger may be transmitted when the automatic parking is stopped by the user operation on the touch panel 18 or the input means 202. Further, when the automatic parking control device 300 detects a failure of the own vehicle, the automatic parking may be stopped, and at that time, the end trigger may be transmitted. When the communication between the automatic parking control device 300 and the mobile terminal 200 is interrupted, the automatic parking control device 300 may stop the automatic parking.

In the above-described embodiment, the case where the remote control determination unit 340 is provided in the vehicle control device has been described, but it may be provided in the mobile terminal instead of the vehicle control device. Further, when a communication network such as the Internet is used, the remote control determination unit 340 may be provided in the server.

For example, the configuration can be such that, in an automatic driving system including a vehicle control device that performs automatic parking control of parking an own vehicle at a final parking position, and a mobile communication device that can perform transmission and reception with the vehicle control device, a remote control determination unit is provided in a mobile terminal as the mobile communication device. The automatic driving system includes the vehicle control device and the mobile communication device. The vehicle control device includes a storage unit that stores information on a running route to the final parking position and information on obstacles existing in the periphery of the running route, and a self-position estimation unit that estimates an own vehicle position based on the information stored in the storage unit and information acquired by an outside world recognition unit that recognizes information of an outside world of the own vehicle Then, the mobile communication device includes a remote control determination unit that determines whether or not the remote automatic parking of the own vehicle is possible based on the own vehicle position estimated by the self-position estimation unit, a notification unit that notifies a user that the remote automatic parking is possible by at least one of sound vibration or display when the remote control determination unit determines that the remote automatic parking is possible, and a processing unit that executes a process of activating a remote operation application for performing the remote automatic parking of the own vehicle.

Further, the configuration can be such that, in an automatic driving system including a vehicle control device that performs automatic parking control of parking an own vehicle at a final parking position, a server that can perform transmission and reception with the vehicle control device, and a mobile communication device that can perform transmission and reception with the server, the remote control determination unit 340 is provided in the server.

The automatic driving system includes the vehicle control device, the server, and the mobile communication device. The vehicle control device includes a storage unit that stores information on a running route to the final parking position and information on obstacles existing in the periphery of the running route, and a self-position estimation unit that estimates an own vehicle position based on the information stored in the storage unit and information acquired by an outside world recognition unit that recognizes information of an outside world of the own vehicle Then, the server includes a remote control determination unit that determines whether or not remote automatic parking of the own vehicle is possible based on the position of the own vehicle estimated by the self-position estimation unit. Further, the mobile communication device includes a notification unit that notifies a user that the remote automatic parking is possible by at least one of sound vibration or display when the mobile communication device receives a determination result that the remote automatic parking is possible from the server, and a processing unit that executes a process of activating a remote operation application for performing the remote automatic parking of the own vehicle

Although the embodiments of the present invention have been described in detail above, the present invention is not limited to the embodiments mentioned above, and various design changes can be made without departing from the spirit of the present invention described in the claims. For example, the embodiments mentioned above have been described in detail for easy understanding of the present invention, and are not necessarily limited to those having all the configurations described. Further, a part of the configuration of one embodiment can be replaced with the configuration of another embodiment, and further, the configuration of one embodiment can be added to the configuration of another embodiment. In addition, it is possible to add, delete, and replace other configurations for a part of the configuration of each embodiment.

### REFERENCE SIGNS LIST

1 drive motor
2 electro-hydraulic brake
3 electric power steering
4 steering angle sensor
5 electronic control unit
6 accelerator pedal
7 brake pedal
8 shift lever
11 to 14 camera
200 mobile terminal
201 touch display
202 input means
203 communication means
210 button
300 automatic parking control device
310 outside world recognition unit
320 self-position estimation unit
321 GNSS
330 storage unit
350 communication means
401 final parking position
402 getting-out position
403 recording start point
404 activation trigger transmission position
405 running route
406 automatic driving startable start point
407 obstacle

1. A vehicle control device, comprising:
a storage unit that stores a running route to a final parking position and peripheral obstacles;
a self-position estimation unit that estimates an own vehicle position based on information from an outside world recognition unit; and
a remote control determination unit that determines that remote automatic parking of the own vehicle is possible based on information stored in the self-position estimation unit and information stored in the storage unit,
wherein the remote control determination unit compares the information from the self-position estimation unit and the information from the storage unit, and determines that the remote automatic parking is possible on a condition that it is determined that the own vehicle is on the running route stored in advance.

2. The vehicle control device according to claim 1, further comprising a communication unit that transmits a result to an outside when the remote control determination unit determines that the remote automatic parking is possible.

3. The vehicle control device according to claim 2, wherein the self-position estimation unit estimates the own vehicle position by a matching process of collating the information stored in the storage unit with information acquired from an outside world information recognition unit that recognizes information of an outside world of the own vehicle.

4. The vehicle control device according to claim 3, wherein the remote control determination unit determines that the remote automatic parking is possible when the own vehicle is on the running route.

5. The vehicle control device according to claim 3, wherein the remote control determination unit determines that the remote automatic parking is possible when the own vehicle position is estimated by the self-position estimation unit.

6. The vehicle control device according to claim 3, wherein the remote control determination unit determines that the remote automatic parking is possible when a signal for automatically parking the own vehicle is input.

7. The vehicle control device according to claim 3,
wherein the remote control determination unit compares the information from the self-position estimation unit and the information from the storage unit, and when the own vehicle is off the running route that is stored in advance, the remote control determination unit determines that the remote automatic parking is impossible, and
wherein the communication unit transmits a fact that the remote automatic parking is impossible to the outside.

8. An automatic driving system, comprising:
the vehicle control device according to claim 2; and
a mobile communication device including:
a notification unit that notifies a user of a state of a determination result that the remote automatic parking is possible by at least one of sound vibration or display when the mobile communication device receives the determination result from the vehicle control device; and
a processing unit that executes a process of activating a remote operation application for performing the remote automatic parking of the own vehicle.

9. The automatic driving system according to claim 8,
wherein, when the remote control determination unit determines that the remote automatic parking is impossible, the communication unit transmits the determination result to the mobile communication device, and
wherein, when the mobile communication device receives the determination result that the remote automatic parking is impossible, the process of the remote control application by the processing unit is terminated.

10. The automatic driving system according to claim 8, wherein the mobile communication device is a smartphone.

11. The automatic driving system according to claim 8,
wherein the communication unit transmits possible/impossible information by the remote control determination unit to a server, and
wherein the mobile communication device receives a result via the server.

12. The automatic driving system according to claim 8, wherein, when communication between the mobile communication device and the communication unit is interrupted, the automatic driving of the own vehicle is stopped.

13. An automatic driving system including a vehicle control device that performs automatic parking control of parking an own vehicle at a final parking position, and a mobile communication device that can perform transmission and reception with the vehicle control device,
wherein the vehicle control device includes:
a storage unit that stores information on a running route to the final parking position and information on obstacles existing in a periphery of the running route; and
a self-position estimation unit that estimates an own vehicle position based on the information stored in the storage unit and information acquired by an outside world recognition unit that recognizes information of an outside world of the own vehicle, and
wherein the mobile communication device includes:
a remote control determination unit that determines whether or not the remote automatic parking of the own vehicle is possible based on the own vehicle position estimated by the self-position estimation unit;
a notification unit that notifies a user that the remote automatic parking is possible by at least one of sound vibration or display when the remote control determination unit determines that the remote automatic parking is possible; and
a processing unit that executes a process of activating a remote operation application for performing the remote automatic parking of the own vehicle.

14. An automatic driving system including a vehicle control device that performs automatic parking control of parking an own vehicle at a final parking position, a server that can perform transmission and reception with the vehicle control device, and a mobile communication device that can perform transmission and reception with the server,
wherein the vehicle control device includes:
a storage unit that stores information on a running route to the final parking position and information on obstacles existing in a periphery of the running route; and
a self-position estimation unit that estimates an own vehicle position based on the information stored in the storage unit and information acquired by an outside world recognition unit that recognizes information of an outside world of the own vehicle,
wherein the server includes a remote control determination unit that determines whether or not the remote automatic parking of the own vehicle is possible based on the own vehicle position estimated by the self-position estimation unit, and
wherein the mobile communication device includes:
a notification unit that notifies a user that the remote automatic parking is possible by at least one of sound vibration or display when the mobile communication device receives a determination result that the remote automatic parking is possible from the server; and
a processing unit that executes a process of activating a remote operation application for performing the remote automatic parking of the own vehicle.
